(19) United States
(12) Patent Application Publication
(10) Pub. No.: US 2004/0011590 A1
(43) Pub. Date: Jan. 22, 2004

(54) Extension ladder roller device

(76) Inventor: Paul E. Quick, Charlotte, NC (US)

Correspondence Address: David P. Lhota, Stearns Weaver Miller, et al., Suite 1900, 200 East Broward Boulevard, Fort Lauderdale, FL, 33301, US

(21) Appl. No.: 10/454,753

(22) Filed: Jun. 4, 2003

Related U.S. Application Data
(60) Provisional application No. 60/385,649, filed on Jun. 4, 2002.

(51) Int. Cl. E06C 7/42

(52) U.S. Cl. 182/108; 182/107

(57) ABSTRACT

An extension ladder roller device that is mountable to an extension ladder for extending and retracting the ladder while it is leaning against a structure, wherein the extension ladder includes at least one housing, at least one caster and structure for securing the device to a ladder. The ladder roller may alternatively be incorporated with the ladder during manufacturing.

### CROSS REFERENCE TO RELATED APPLICATIONS

This application claims the benefit of provisional patent application Serial No. 60/385,649 filed Jun. 4, 2002.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to extension ladders, and more particularly, to a device that is mountable to an extension ladder to facilitate easy movement of the ladder, on a given surface, either upward or downward without having to lift the ladder from the surface.

2. Description of the Background Art

While extension ladders are commonly used in the construction, home repair and painting industries, they are not easily adjusted or moved. Moving or adjusting the height of an extension ladder is difficult because the top end of the ladder must be lifted off the wall or structure that it is leaning against. The most common practice of extending a ladder, which is resting vertically against a structure, is to push or pull the top of the ladder away from the building surface from ground level. A user must next pull on an extension rope to extend the ladder upward, prior to the ladder falling back against the building's surface. With longer and heavier ladders this process can be extremely difficult and unsafe. As the ladder is extended, the ladder becomes more difficult to maneuver and the weight transfer makes the ladder more likely to kick out at the bottom when an operator is pushing or pulling against it. As the operator loses full control over the ladder, the chances of an accident or injury are increased. If a device existed that could make it easier to maneuver or adjust an extension ladder while decreasing the risk of injury it would be well received. There are no known devices that address this problem. Accordingly, there exist a need for such a device. The instant invention addresses this unfulfilled need in the prior art.

### BRIEF SUMMARY OF THE INVENTION

In light of the foregoing, it is an object of the present invention to provide an extension ladder roller device that is adapted for attachment to an extension ladder and allows adjustment of the ladder while it is leaning against a wall or other surface.

It is another object of the instant invention to provide an extension ladder roller device that does not scratch the surface it leans against.

It is also an object of the instant invention to provide an extension ladder roller device that prevents a ladder from sliding sideways when properly mounted to the ladder.

It is a further object of the instant invention to provide extension ladder roller device that is easy to use.

It is an additional object of the instant invention to provide an extension ladder that may be adjusted while the ladder is leaning against a wall, used without scratching the surface and used without sliding sideways.

It is another object of the instant invention to provide an extension ladder with rollers and an extension ladder roller adapter that may be manufactured with existing techniques at relatively low costs.

In light of these and other objects, the instant invention comprises an extension ladder roller device that is mountable to an extension ladder and allows an operator to simply pull a ladder's extension rope to easily extend or retract the ladder while it is leaning against a structure. The extension ladder of the instant invention comprises at least one housing, at least one caster and structure for securing the device to a ladder. To use the instant invention, an extension ladder roller is preferably mounted to each leg of a ladder. The ladder roller may alternatively have a housing that mounts to both legs of the ladder or that is incorporated with the ladder during manufacturing. When using the instant invention, the extension ladder will glide over the surface that the ladder is leaning against without damaging the surface of the structure. In addition, the ladder roller of the instant invention may reduce operator injuries by increasing the lateral traction of the ladder thereby reducing the risk of sliding sideways.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a first preferred embodiment of the extension ladder roller mounted to an extension ladder in accordance with the instant invention.

FIG. 2 is a perspective view of a second preferred embodiment of the extension ladder roller mounted to an extension ladder in accordance with the stabilizer version of the instant invention.

FIG. 3 is a perspective view of the first preferred embodiment of the extension ladder roller mounted to an extension ladder in accordance with the instant invention.

FIG. 4 is a plan view of the first preferred embodiment of the extension ladder roller in accordance with the instant invention.

FIG. 5 is a side elevational view of the first preferred embodiment of the extension ladder roller in accordance with the instant invention.

FIG. 6 is an end elevational view of the first preferred embodiment of the extension ladder roller in accordance with the instant invention.

FIG. 7 is a perspective view of the second preferred embodiment of the extension ladder roller mounted to an extension ladder in accordance with the stabilizer version of the instant invention.

FIG. 8 is an end elevational view of the second preferred embodiment of the extension ladder roller in accordance with the instant invention.

FIG. 9 is a side elevational view of the second preferred embodiment of the extension ladder roller in accordance with the instant invention.

FIG. 10 is a bottom elevational view of the caster used in the second preferred embodiment of the extension ladder roller in accordance with the instant invention.

FIG. 11 is a plan view of the caster used in the second preferred embodiment of the extension ladder roller in accordance with the instant invention.

### DETAILED DESCRIPTION OF THE INVENTION

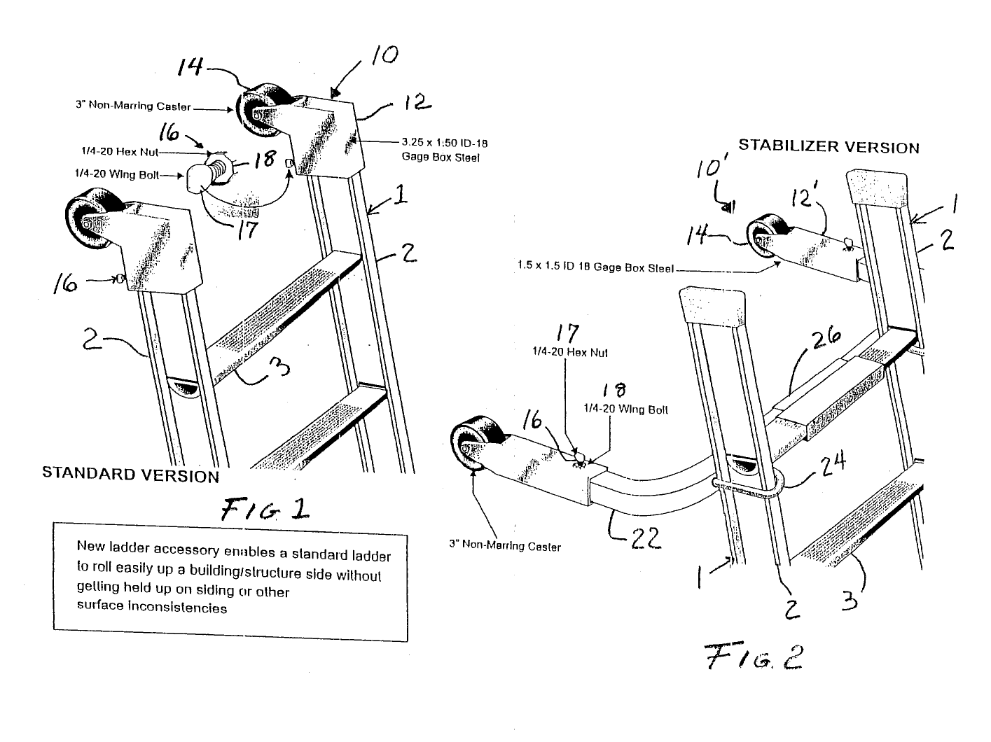

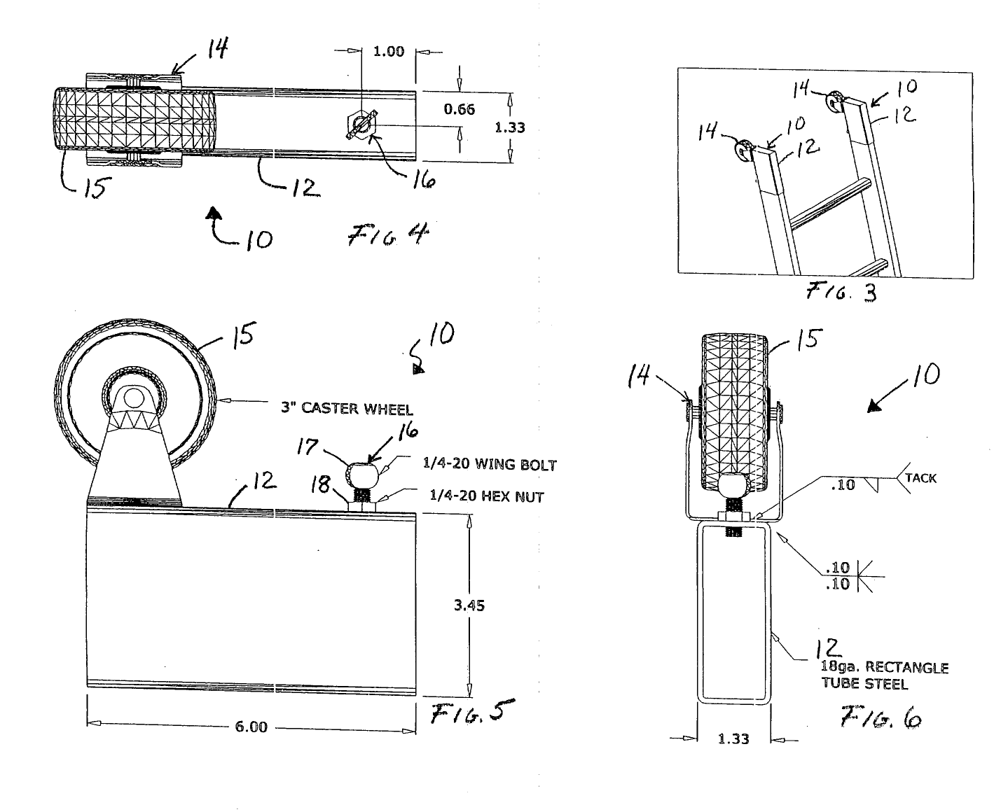

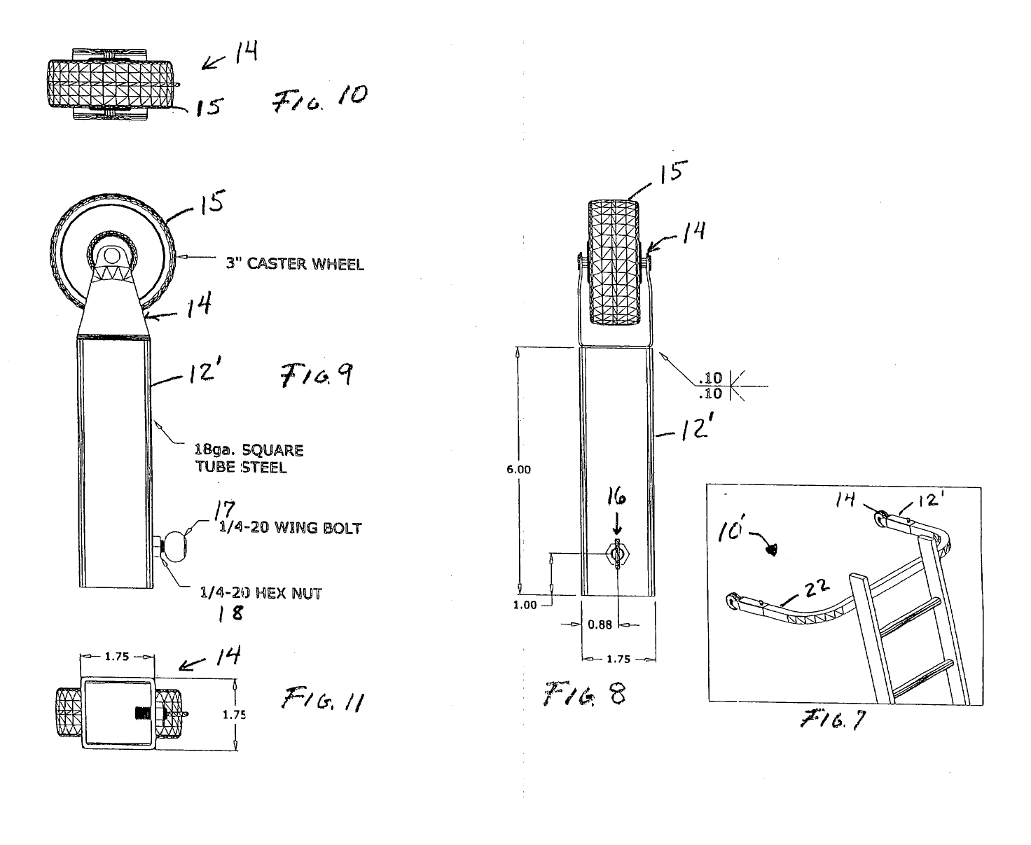

With reference to the drawings, FIGS. 1 to 11 depict the preferred embodiments of the instant invention which is generally referenced as a ladder roller and, or by numeric character 10. The ladder roller 10 comprises a device that mounts to at least one leg of an extension ladder and allows an operator to extend or retract the ladder while it leans against a flat surface or uneven surface (brick, cement block, stucco, lap wood siding, vinyl siding, asphalt shingles, etc.) without having to separate the ladder from the structure. When rolling up an exterior wall, the extension ladder roller 10 will allow the ladder to glide along a surface without getting “hung up” or damaging the surface of the building structure. In addition, the ladder roller 10 provides lateral traction to reduce the risk of sliding sideways when in use.

With reference to FIGS. 1 and 3-6, the ladder roller 10 comprises a housing 12, caster 14 and fastener 16. The ladder roller 10 is designed to mount over the end of a ladder's side support 2. For proper use, a ladder roller 10 should be mounted to each side support 2. In an alternative embodiment, the housing 12 may mount over the ends of both side supports 2. The housing 12 is at least partially hollow such that it defines a sleeve for mounting over the end of at least one of the ladder's side supports 2. The ladder roller 10 combines a caster 14 with metal tubing comprising the housing 12 or 12′, which is easily attached to various extension ladders 1 or typical ladder stabilizers 10′. The caster 14 may comprise a rubber caster, while the housing may comprise either aluminum tubing, or thin wall mild box steel tubing. The casters 14 comprise a frame and wheel 15 that are attached to the housing 12, 12′ by fasteners, such as a wing bolt 17 and hex nut 18.

With reference to FIGS. 2 and 7-11, the ladder extender or stabilizer 10′ comprises a housing 12′, U-shaped stabilizer mount 22, wheel casters 14 and fasteners 16. The housing 12′ comprises a sleeve that fits over the end of the U-shaped stabilizer mount 22. The fasteners 16 secure the housing 12′ in place and may comprise a wing bolt 17 and hex nut 18. The U-shaped stabilizer mount 22 is secured to the ladder 1 and preferably to the side supports 2, by U-bolts 24 and corresponding fasteners. The U-shaped stabilizer mount 22 may also be secured to a ladder rung 3 by a flange-like or clamp-like structure 26.

The housings 12, 12′ may be manufactured from thin walled mild box steel tubing, or an aluminum extruded tubing. The most common and universal size would be 3.25″×1.50″ (inner diameter)×6″ long for the first preferred embodiment of the ladder roller, and 1.50″×1.50″ (inner diameter)×6″ long for the second embodiment 10′, referred to herein as a ladder stabilizer 10′. A 3″ caster may be employed and attached flush with the end of the narrow side of the metal tubing comprising the housing 12 or 12′. Two hex nuts attached to the wider side of the tubing, along with jam bolts, work as mechanical fasteners to attach a ladder roller 10 to the upper end of an extension ladder. For ladder stabilizers 10′, the casters 14 on the ladder roller 10′ are attached to the end of the U-shaped stabilizer mount tubing 22 rather than over the ladder's side support as done in the first preferred embodiment of the invention 10. Hex nuts 18 and bolts or jam bolts 17 may be used as mechanical fasteners.

In using the ladder roller 10 or 10′, an operator slides each of the rollers 10 or 10′ onto either the top end of the ladder 1 itself, or onto the ends of a ladder stabilizer mount 22 (depending on which version is being used). Once in place, the operator securely attaches the ladder roller 10 or 10′ using hex nuts 18 and jam bolts 17.

Although the instant invention is described with primary reference to the ladder rollers 10 and 10′, the invention may also comprise the ladder 1. The ladder rollers 10 and, or 10′ may be removable from the ladder 1 or permanently mounted to the ladder 1. In addition, the dimensions noted herein may vary without departing from the scope and spirit of the instant invention.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A ladder roller device adapted for mounting to the end of at least one of the ladder's side supports, said ladder roller comprising:
a housing tube comprising a passageway and an open end in communication with said passageway, said passageway being adapted for mounting over the end of at least one ladder side support;
at least one wheel rotatably mounted to said housing;
means for securing said wheel to said housing; and
means for securing said housing to a ladder.

2. A ladder roller as recited in claim 1, wherein said wheel securing means comprises:
a flange extending outward from said housing; and
means for rotatably securing said wheel to said flange.

3. A ladder roller as recited in claim 2, wherein said flange comprises two legs projecting from said housing and being substantially parallel and separated a distance that is wider than said wheel.

4. A ladder roller as recited in claim 1, wherein said housing securing means comprises a fastener that penetrates said housing and engages the ladder.

5. A ladder roller as recited in claim 1, wherein said housing securing means comprises:
a substantially U-shaped frame adapted for having at least one said housing mounted to an end of said frame.

6. A ladder as recited in claim 5, wherein said frame is adapted for supporting two said housings wherein said housing is mountable to said frame at both ends.

7. A ladder roller as recited in claim 6, further comprising:
means for mounting said frame to a ladder.

8. A ladder roller as recited in claim 7, wherein said frame mounting means comprises arcuate bolt fasteners.
